(19) United States
(12) Patent Application Publication
(10) Pub. No.: US 2026/0140969 A1
(43) Pub. Date: May 21, 2026

(54) METHOD AND APPARATUS FOR MULTIFARIOUS GEOGRAPHIC RADIAL POINT INTERPOLATION

(71) Applicant: Precisely Software Incorporated, Burlington, MA (US)

(72) Inventors: Michael Ashmore, Boulder, CO (US); Jessica Hoover, Centreville, MD (US); Jeffrey Rueger, Pittsfield, MA (US); Neena Priyanka, Uttar Pradesh (IN)

(21) Appl. No.: 18/951,863

(22) Filed: Nov. 19, 2024

(51) Int. Cl. G06F 16/29; G01C 21/36

(52) U.S. Cl. CPC G06F 16/29; G01C 21/3667

(57) ABSTRACT

A method for multifarious geographic radial point interpolation includes accessing, by a processing circuit, a database comprising location information for location objects in a geographic area, the location information including at least geographic coordinates associated with the location objects. For each of the location objects, the method includes generating, by the processing circuit, a spread pattern of dot locations around a corresponding location object, the dot locations including geographic locations each being a respective distance away from the corresponding location object and creating, by the processing circuit, a data structure that includes the corresponding location object and each of the dot locations associated with the corresponding location object. The method further includes storing the data structure created for each of the location objects in a storage device for processing by a computing device.

### FIELD OF INVENTION

The disclosure herein relates to geographic location systems and methods. More particularly, the disclosure herein relates to multifarious geographic radial point interpolation.

### BACKGROUND

Geocoding is a term referring to translating a human-readable address (e.g., street address, mailing address, postal address, etc.) into a location (e.g., latitude and longitude) on a map. Geocoding methods may need to handle situations where an address could refer to multiple locations (spatial disambiguation). For instance, if a geospatial point represents an address object, a house is represented by a building footprint polygon, a flood boundary is represented by a polygon that covers half the house, and a wildfire boundary is represented by a polygon that covers the other half of the house, it may be difficult to determine whether the house is in a flood and wildfire risk area using the address point object and risk boundaries. Additionally, some reference datasets often have missing or incomplete geographic coordinates.

The typical method of solving these problems is to buffer all three polygons in the example above and determine whether the three boundaries intersect. If the building footprint boundary does not exist, then the two risk boundaries will be buffered and determined whether both contain the address point. However, the spatial processing to determine whether the three boundaries intersect is costly, slow, and requires substantial memory and compute resources.

As such, there is a need for improved systems and methods for addressing some of the above-mentioned deficiencies.

### SUMMARY

In an embodiment of the present disclosure, a method is disclosed that includes accessing, by a processing circuit, a database includes location information for a plurality of location objects in a geographic area, the location information includes at least geographic coordinates associated with the plurality of location objects. The method also includes for each of the plurality of location objects generating, by the processing circuit, a spread pattern of dot locations around a corresponding location object, the dot locations includes geographic locations each being a respective distance away from the corresponding location object, and creating, by the processing circuit, a data structure that includes the corresponding location object and each of the dot locations associated with the corresponding location object. The method also includes storing, by the processing circuit, the data structure created for each of the plurality of location objects in a storage device for processing by a computing device.

In another embodiment, an apparatus is provided, the apparatus including a processing circuit. The apparatus also includes a memory storing instructions thereon, which, when executed by the processing circuit, configure the apparatus to access a database includes location information for a plurality of location objects in a geographic area, the location information includes at least geographic coordinates associated with the plurality of location objects. Execution of the instructions further configures the apparatus to, for each of the plurality of location objects: 1) generate a spread pattern of dot locations around a corresponding location object, the dot locations including geographic locations each being a respective distance away from the corresponding location object and 2) create a data structure that includes the corresponding location object and each of the dot locations associated with the corresponding location object. Execution of the instructions further configures the apparatus to store the data structure created for each of the plurality of location objects in a storage device for processing by a computing device.

In another embodiment, a non-transitory computer-readable storage medium is disclosed, the computer-readable storage medium having executable instructions stored thereon, that when executed by a processing circuit, cause the processing circuit to perform various operations. In some embodiments, the processing circuit is caused to access a database including location information for a plurality of location objects in a geographic area, the location information includes at least geographic coordinates associated with the plurality of location objects. Additionally, for each of the plurality of location objects, the processing circuit is configured to generate a spread pattern of dot locations around a corresponding location object, the dot locations including geographic locations each being a respective distance away from the corresponding location object and create a data structure that includes the corresponding location object and each of the dot locations associated with the corresponding location object. The processing circuit is further configured to store the data structure created for each of the plurality of location objects in a storage device for processing by a computing device.

Non-transitory computer program products (i.e., physically embodied computer program products) are also described that store instructions, which, when executed by one or more data processors (i.e., processing circuit) of one or more computing systems, cause at least one data processor to perform operations herein. Similarly, computer systems are also described, which may include one or more data processors and memory coupled to the one or more data processors. The memory may temporarily or permanently store instructions that cause at least one processor to perform one or more of the operations described herein. In addition, methods can be implemented by one or more data processors, which are either within a single computing system or distributed among two or more computing systems. Such computing systems can be connected and can exchange data and/or commands or other instructions or the like via one or more connections, including but not limited to a connection over a network (e.g., the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims.

### BRIEF DESCRIPTION OF THE DRAWINGS

By way of example, specific embodiments of the disclosed methods and devices will now be described, with reference to the accompanying drawings, in which:

FIG. 1 illustrates an example geographic area in accordance with one embodiment.

FIG. 2 is a network diagram illustrating an example system in accordance with one embodiment.

FIG. 3 is a block diagram of an apparatus in accordance with one embodiment.

FIG. 4A is a block diagram of a database in accordance with one embodiment.

FIG. 4B illustrates example data structures in accordance with one embodiment.

FIG. 5 illustrates a spread pattern of dot locations in accordance with one embodiment.

FIG. 6 illustrates an example geographic area with a spread pattern of dot locations thereon in accordance with one embodiment.

FIG. 7 is a flow chart illustrating various operations of method in accordance with one embodiment.

It should be understood that the drawings are not necessarily to scale and that the disclosed embodiments are sometimes illustrated diagrammatically and in partial views. In certain instances, details which are not necessary for an understanding of the disclosed methods and devices or which render other details difficult to perceive may have been omitted. It should be further understood that this disclosure is not limited to the particular embodiments illustrated herein. In the drawings, like numbers refer to like elements throughout unless otherwise noted.

### DETAILED DESCRIPTION

Described herein are improved systems and methods for geocoding. More specifically, the present disclosure describes techniques that consider the spatial relationships of known addresses and employs interpolation techniques that can help resolve ambiguities and assign more accurate coordinates to addresses. Interpolation techniques are applied to fill in the gaps and provide more complete spatial information. The disclosed techniques represent an improvement in global positioning systems (GPS) and location determination technology. Namely, the techniques, systems, and methods provided herein help to improve the efficacy and reduce the processing, memory, and power demands associated with spatial processing when comparing one or more spatial polygonal boundaries with point objects. The disclosed techniques make these improvements by comparing a point location to a polygon (i.e., that represents a location), versus comparing a polygon to another polygon. The improved techniques described herein improve the functioning of a computer by minimizing memory utilization and processing consumption during location and geolocation calculations.

Determining whether a point is inside a polygon is computationally less intensive than a polygon intersection. The point-in-polygon algorithm typically involves simple geometric calculations, such as ray casting or winding number tests, which can be computationally efficient. On the other hand, polygon intersection involves checking the overlap or intersection between two polygons, which can be more complex and computationally intensive. There are various algorithms for polygon intersection, such as the Sweep Line algorithm or the Boolean operations on polygons, and their efficiency can vary based on the input data.

On the other hand, randomly generating coordinates around a confirmed latitude/longitude address point provides a method that simulates spatial variation in a specific area. It further allows conducting simulations and study patterns and spatial distribution. In testing and validation scenarios, this helps to assess the robustness and accuracy of algorithms or systems that work with spatial data. This can be used for data augmentation for machine learning and data science tasks involving geospatial data. By introducing variability around known locations, these techniques can enhance the diversity of the dataset, improving the performance and generalization of machine learning models.

In summary, the disclosed techniques, methods, apparatuses, and systems, offer versatility and applicability across various domains, providing advantages in testing, privacy preservation, data augmentation, geospatial analysis, and more.

Moreover, the disclosed method for multifarious geographic radial point interpolation improves related technology by extending spatial information, facilitating spatial analysis, and supporting decision-making across various applications in geography, urban and infrastructure planning, location-based services, risk assessment, and beyond.

Multifarious geographic radial point interpolation is an approach that involves interpolating values at various geographic points using a radial interpolation technique. Using the address point as the center, radiate in all directions for a specified distance (e.g., 30 Meters) and create additional address point objects at a specified density and frequency. The interpolation radius will provide recommendations to dynamically adjust based on barriers to data points such as geographical (hills, mountains), man-made features (dams, national parks, large vacant land), or water bodies. This adaptive approach ensures better performance for point-density generation.

The disclosed techniques provide embodiments whereby a spread pattern of points is generated using a method to generate random coordinates within a specified geographic area. The geographic area will be defined by a radial distance referred to herein as a logical zone (e.g., circular or some other suitable shape). If the radial distance is, for example, 30 meters, the methods described herein define that area and use a random number generator to create the random coordinates. This will generate a “scatter plot” within the specified area. The disclosed techniques also include or consider neighboring points within a radius of the target location and assign weights to these points based on their distance. As such, some of the random dot locations are located outside of the logical zone.

With general reference to notations and nomenclature used herein, one or more portions of the detailed description which follows may be presented in terms of program procedures executed on a computer or network of computers. These procedural descriptions and representations are used by those skilled in the art to most effectively convey the substances of their work to others skilled in the art. A procedure is here, and generally, conceived to be a self-consistent sequence of operations leading to a desired result. These operations are those requiring physical manipulations of physical quantities. Usually, though not necessarily, these quantities take the form of electrical, magnetic, or optical signals capable of being stored, transferred, combined, compared, and otherwise manipulated. It proves convenient at times, principally for reasons of common usage, to refer to these signals as bits, values, elements, symbols, characters, terms, numbers, or the like. It should be noted, however, that all of these and similar terms are to be associated with the appropriate physical quantities and are merely convenient labels applied to those quantities.

Further, these manipulations are often referred to in terms, such as adding or comparing, which are commonly associated with mental operations performed by a human operator. However, no such capability of a human operator is necessary, or desirable in most cases, in any of the operations described herein that form part of one or more embodiments. Rather, these operations are machine operations. Useful machines for performing operations of various embodiments include digital computers as selectively activated or configured by a computer program stored within that is written in accordance with the teachings herein, and/or include apparatus specially constructed for the required purpose or a digital computer. Various embodiments also relate to apparatus or systems for performing these operations. These apparatuses may be specially constructed for the required purpose. The required structure for a variety of these machines will be apparent from the description given.

Embodiments of the present disclosure will now be described more fully hereinafter with reference to the accompanying drawings, in which several exemplary embodiments are shown. The subject matter of the present disclosure, however, may be embodied in many different forms and types of methods and devices aircraft taxiing systems, and should not be construed as limited to the embodiments set forth herein. Rather, these embodiments are provided so that this disclosure will be thorough and complete, and willfully convey the scope of the subject matter to those skilled in the art. In the drawings, like numbers refer to like elements throughout.

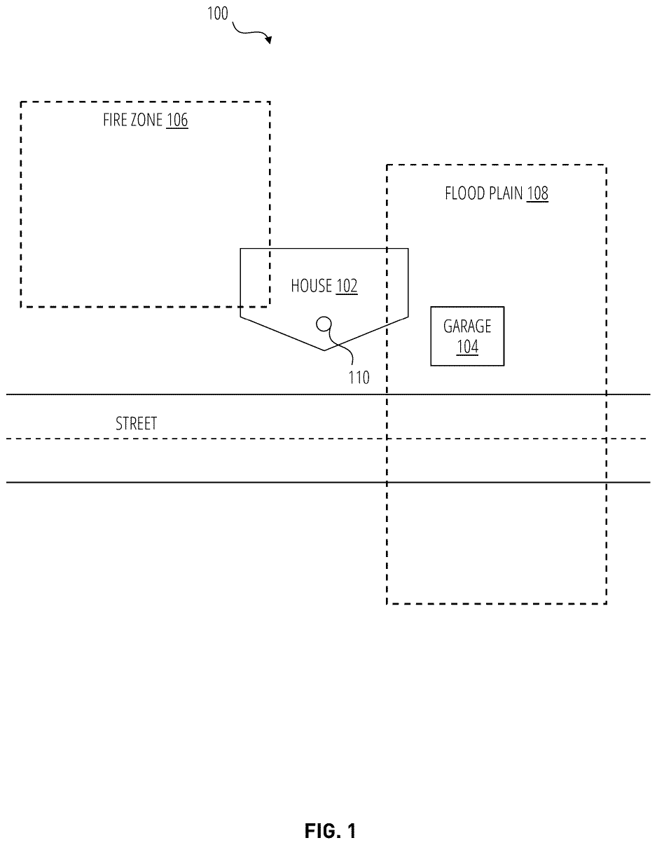

FIG. 1 illustrates a geographic area 100 including a location object represented by house 102. The house 102 is illustrated on the geographic area 100 as a polygon and includes a detached garage 104, also represented as a polygon. The house 102 and detached garage 104 may be represented on a map or in a database of location objects using a single human-readable address, such as a street address. The address point 110 is an example point that would be seen on a map to represent the street address associated with the house 102 or location object.

In some cases, it may be desirable to determine whether a portion of the house 102 or the garage 104 is located within an obstacle or within a risk area. For example, for insurance purposes, it may be desired to determine whether the house 102 or the garage 104 are located within a fire zone 106 or a flood plain 108. In some other examples, it may be desired to determine whether the house 102 or garage 104 is nearby a river, ocean, volcano, or any other hazard or risk area. While insurance is one reason for determining whether the proximity of the house 102 or garage 104 is nearby a hazard, there may be other reasons for determining such proximity. For example, for package delivery, emergency services, zoning, residential and commercial planning, as well as many other possible reasons.

In some cases, the street address associated with the house 102 and garage 104 can be represented using a single address point 110. The address point 110 can be located at a central location of the property, the house 102, the garage 104, etc. The address point 110 can also be located at another section of the property associated with the street address of the house 102. For example, instead of being located in the center of the house 102, the address point 110 may be located at a corner of the house 102 or at the garage 104.

As such, in some instances, the address point 110 may not precisely represent the property. For example, the address point 110 shown in FIG. 1 does not overlap with the fire zone 106 or the flood plain 108. Therefore, a location tool, such as a map or GPS, might indicate that the property is not located in the fire zone 106 or the flood plain 108.

As discussed above, it is computationally complex to determine whether the polygon of the house 102 and/or the polygon of the garage 104 overlap with either the polygons of the fire zone 106 and the flood plain 108. The techniques, systems, and methods described herein help to provide a better characterization of the location of the location object to reduce this computational and memory usage burden.

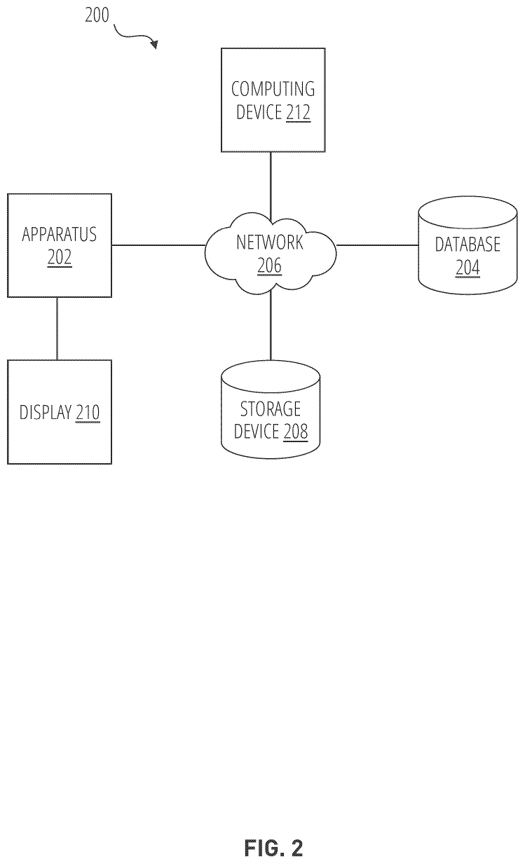

FIG. 2 is a network diagram illustrating an example system 200 for performing multifarious geographic radial point interpolation. In some embodiments, the system 200 includes an apparatus 202 for performing the computational aspects of the interpolation. The system 200 may further include a database 204 containing geographic location data. The apparatus 202 can communicate with the database 204 to extract or query data over network 206. Also connected to the network 206 is storage device 208, wherein the apparatus 202 can store results of the operations described herein. Alternatively, or in addition, the apparatus 202 can display results to a display 210, as described herein.

In some embodiments, the apparatus 202 includes a computing system, such as a server, personal computer (PC), mobile device, smartphone, cloud server, desktop, or any other suitable computing system. In some embodiments the apparatus 202 has an integrated display 210, such as a screen, touchscreen, monitor, or any other suitable display. In other embodiments, the display 210 is separate from the apparatus 202 and connected thereto by one or more cables so that the apparatus 202 can send data to the display 210 to display thereon. Alternatively, the apparatus 202 is in wireless communication with the display 210 and sends data thereto for display via a wireless communication protocol. For example, the apparatus 202 can be in communication with the display 210 via BlueTooth®, wireless fidelity (Wi-Fi), or any other suitable wireless communication protocol.

In some embodiments, the database 204 is embodied as a server, cloud server, storage server, storage area network (SAN) device, or any other suitable storage device. The network 206 can include any suitable network such as a local area network (LAN), wireless local area network (WLAN), wide area network (WAN), mobile communications network (e.g., 3G, 4G, long term evolution (LTE), 5G, 6G, etc.), the Internet, or any other suitable network.

The apparatus 202 may have an application operating thereon and may communicate with the database 204 via an application programming interface (API). The API may be used to query the database 204 and extract data therefrom. Alternatively, the apparatus 202 may communicate with the database 204 via file transfer protocol (FTP), secure file transfer protocol (SFTP), secure sockets layer and transport layer security (SSL/TLS), a transport control protocol (TCP) connection, or any other suitable communications method.

In some embodiments, the storage device 208 may be embodied as a server, cloud server, storage server, SAN device, or any other suitable device. In fact, the storage device 208 and the database 204 may be embodied in the same server or same storage device. A computing device 212 may be included in the system 200, the computing device 212 being configured to access data structures stored in the storage device 208 and process them (e.g., display them on a map or determine if a location object is located in a hazard) as discussed herein.

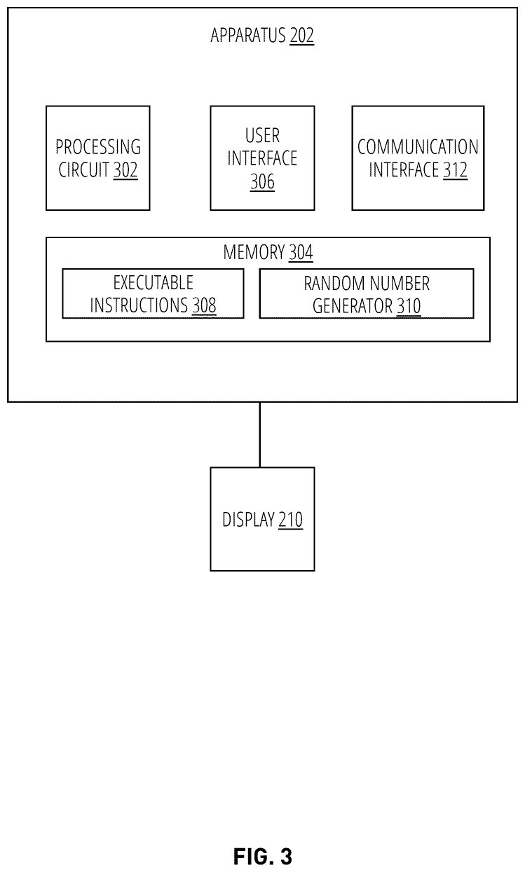

FIG. 3 is a block diagram of an example apparatus 202 according to some embodiments of the present disclosure. In some embodiments, the apparatus 202 includes a processing circuit 302 and memory 304 storing executable instructions 308 thereon. The memory 304 may also include a random number generator 310 used to help generate a spread pattern of dot locations as discussed hereinbelow. The apparatus 202 may further include a user interface 306 and a communication interface 312.

In some embodiments, the user interface 306 is a screen, touchscreen, button, plurality of buttons, display, toggle, or other suitable user interface to provide output to a user or receive input from the user. In some embodiments, the user interface 306 may be used to receive a parameter from a user using the apparatus 202.

The communication interface 312 can be used to communicate over the network 206 with the storage device 208 and the database 204. In some embodiments, the communication interface 312 is a wired or a wireless interface. In such embodiments, the communication interface 312 may use Ethernet, wireless Ethernet, a wireless communications protocol (e.g., 3G, 4G, LTE, 5G, 6G, etc.), or any other suitable communications protocol to communicate with the database 204 or the storage device 208.

In some embodiments, the processing circuit 302 can include a central processing unit (CPU), processor, microprocessor, application specific integrated circuit (ASIC), multi-core processor, or any other suitable processing circuit. In some embodiments, the memory 304 can include any suitable memory device such as random access memory (RAM), read only memory (ROM), a hard drive, a solid disk drive, cache memory, or any combination thereof.

The executable instructions can include a computer program or application stored in the, for example, hard drive or RAM of the memory 304, or a combination of both. The random number generator 310 can include a random number generator or a pseudorandom number generator embodied in a computer program or other software.

In some embodiments, the processing circuit 302 is configured to execute the executable instructions 308, which, when executed, cause the processing circuit 302 to perform various operations described herein. For example, in some embodiments, the processing circuit 302 is configured to access the database 204, which comprises location information for a plurality of location objects in a geographic area. In FIG. 1, the street address of the house 102 is equivalent to the location objects in the geographic area 100 of FIG. 1. The location information can include at least geographic coordinates (e.g., latitude and longitude coordinates) associated with the plurality of location objects. For example, the database 204 can include a plurality of latitude and longitude coordinates, each associated with a different street address for a particular city, state, locality, neighborhood, or other geographic area 100.

Each of the location objects represents an address (e.g., street address, postal address, etc.) used to describe a portion of real property located in the geographic area, and the geographic coordinates are the latitude and longitude coordinates located within the portion of real property.

In some embodiments, the processing circuit 302 is configured to obtain the location information for the plurality of location objects, or a subset thereof. For example, the processing circuit 302 can obtain the location information for the plurality of location objects using a query, such as a structured query language (SQL) query, statement, or other database query mechanism (e.g., Python, PHP, C #, R or other suitable database languages). The relevant data can be obtained and temporarily stored in memory 304 on the apparatus 202, or the data can be extracted and processed in real-time as needed from the database 204.

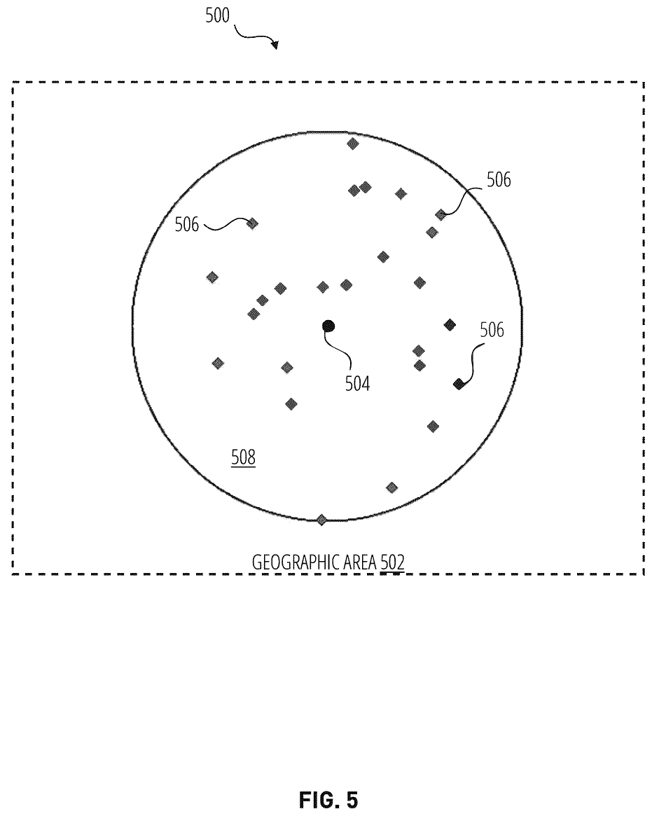

In some embodiments, for each of the plurality of location objects, the processing circuit 302 is configured to generate a spread pattern of dot locations around a corresponding location object. FIG. 5 illustrates one example of the spread pattern 500 of dot locations around a corresponding location object 504. As described herein, the location object can be a location representative of a home, apartment, dorm, library, building, business, university, lot, land, farm, or any other suitable real property.

In some embodiments, the dot locations include geographic locations each being a respective distance away from the corresponding location object. In some embodiments, the spread pattern of dot locations is generated by the processing circuit 302 by using the random number generator 310 to generate random coordinates around the corresponding location object. The random number generator can be configured to only generate random geographic coordinates (e.g., latitude and longitude coordinates). That is, the location object is at the center and random coordinates for the spread pattern of dot locations are generated and the random coordinates are the locations of the dot locations. The processing circuit 302 not only tracks the random coordinates themselves, but also the distance from the random coordinates to the centered location object.

In some cases, a corresponding location object may be close to a known exclusion zone. An exclusion zone may include, for example, one or more of the following: hills, mountains, man-made features, dams, national parks, large vacant land, and bodies of water. In some embodiments, the processing circuit 302 is configured to adjust individual dot locations to not be collocated with known exclusion zones. For example, if a randomly placed dot location falls within an exclusion zone, for example, the ocean, the processing circuit 302 may move the randomly placed dot location to a location that does not fall within the exclusion zone. In some embodiments, the processing circuit 302 may move the dot location to an edge of the water body towards the center of an adjacent land parcel. In some other embodiments, the dot location may be moved such that it falls within a predefined area, such as a C-shaped building or other predefined shape.

In some embodiments, to define the range or radius of where the random dot locations can be generated, the executable instructions 308 further configure the processing circuit 302 to generate a logical zone of the geographic area having the corresponding location as a center point thereof and the logical zone having a radius according to a parameter (e.g., radius of the logical zone). For example, the logical zone can be a circular area around the corresponding location (e.g., at the center point of the circular area), a rectangular area, or any suitable shape. In some embodiments, the processing circuit 302 is further configured to generate the spread pattern of dot locations within the logical zone. The logical zone effectively adds limits to the latitude and longitude of each of the dot locations in the spread pattern.

In some embodiments, the processing circuit 302 may still generate dot locations outside the logical zone, and those dot locations can be used to provide additional information about the corresponding location. For example, the dot location outside the zone may fall on a neighbor's property, a lake, the ocean, or some other location. This might inform the processing circuit 302, indicating that the corresponding location is not itself overlapping with a hazard, but the house next door might be overlapping with the hazard.

In some embodiments, the size or shape of the logical zone can be changed, altered, or selected by a user using the apparatus 202. For example, in some embodiments, the instructions further configure the apparatus 202 to receive an input, via the user interface 306, including the parameter, setting the radius (or shape) of the logical zone to be generated. The user interface 306 can display, via display 210, a window (e.g., computer application window) or other item for the user to select a radius, shape, size or other characteristic of the logical zone. The user can then select on the display 210 (e.g., a touchscreen), or via another button, the radius, shape, size, or other characteristics of the logical zone.

In some other embodiments, the processing circuit 302 can be configured to set the parameter to be a predefined radius, or shape, based on whether the corresponding location object is located in a rural or urban area. For example, in some embodiments, the radius or size of the logical zone may be larger when the corresponding location object is located in the rural area than in the urban area.

In some other embodiments, the processing circuit 302 is further configured to receive input parameters including a number of dot locations to generate, a density of the dot locations, and/or a maximum distance from the corresponding location object that the dot locations can be generated. For example, the user interface 306 can receive an input of fifty (50) dot locations, one (1) dot location per square meter, and a maximum distance of fifty (50) meters from the centralized corresponding location object. In such embodiments, the processing circuit 302 is further configured to generate the dot locations according to the input parameters. In some other embodiments, the processing circuit 302 can generate additional dot locations that are outside of the parameters. As discussed above, these other dot locations can be used to further characterize the centralized corresponding location object (e.g., with respect to a neighbor's property, with respect to adjacent land, or other geographic locations).

In some embodiments, once the random dot locations are generated according to the description above, the processing circuit 302 is further configured to create a data structure that includes the corresponding location object and each of the dot locations associated with the corresponding location object. For example, in some embodiments, the processing circuit 302 is configured to determine attributes for each of the dot locations associated with the corresponding location object and then associate the attributes with corresponding ones of the dot locations and insert the attributes into the data structure. The attributes include at least a distance from the corresponding dot location to the corresponding location object and geographic coordinates (e.g., latitude and longitude coordinates) for the corresponding dot location.

In some embodiments, each centralized location object will have a corresponding data structure associated therewith, and each of those data structures will include a list of the corresponding dot locations associated with the location object. One or more of these data structures can be created based on the number of centralized location objects there are. A user of the apparatus 202 can indicate how many and which of the location objects are to be processed and data structures generated.

In some embodiments, once the data structure is generated, the processing circuit 302 is further configured to store the data structure created for each of the plurality of location objects in the storage device 208 for processing by another computing device, such as computing device 212. For example, in some embodiments, the computing device 212 may be configured to access the data structures stored by the processing circuit 302 to determine whether a location object is collocated with one or more hazards (e.g., fire zone) or to determine whether the location object is nearby another geographic feature.

Instead of the location object being represented by a polygon, and comparing the polygon to the hazard or geographical feature, each of the location objects with corresponding data structures stored in the storage device 208 is represented by the corresponding data structure with the plurality of dot locations listed therein. The coordinates of the dot locations can be compared to the polygon representing the hazard or geographical feature. If one of the dots of the dot locations for a corresponding location object is collocated with the hazard or geographical feature, the distance from the location object to the hazard or geographical feature can be determined because the data structure includes the distance between a given location dot and the coordinates of the location object.

In some embodiments, execution of the instructions further configures the processing circuit 302 to remove or selectively retain a subset of the dot locations present in the data structure for a corresponding location object. The processing circuit 302 can determine which of the dot locations to retain based on other reference data (e.g., feature extraction from imagery or remotely sensed data of other kinds such as mobile devices) to only store certain important locations for the corresponding location object. For example, a location object may be represented by dot locations on an airport door, a runway, or the main airport building, or any combination thereof. As another example, a residential address location object (e.g., someone's house) can be represented using a dot location on their driveway entrance, garage door, front door, or any other suitable location. That is the location object can be represented by multiple dot locations within the boundary of the location object such that a single residential address, business address, etc. is represented by multiple dot locations as defined herein.

In some embodiments, execution of the instructions further configures the processing circuit 302 to receive a request to display a representation of an input location object. For example, the processing circuit 302 may receive an input on the user interface 306 to display a location object. The processing circuit 302 is then configured to access the storage device 208 and locate the corresponding data structure for the location object that corresponds to the input location object. Once located, the processing circuit 302 can display on a map interface (e.g., a mapping application on the display 210), the representation including the location object (e.g., at the center) that corresponds to the input location object and the spread pattern of dot locations associated with the location object. The location object and the spread pattern of dot locations can all be depicted as dots on the map interface, either on the user interface 306 or the display 210.

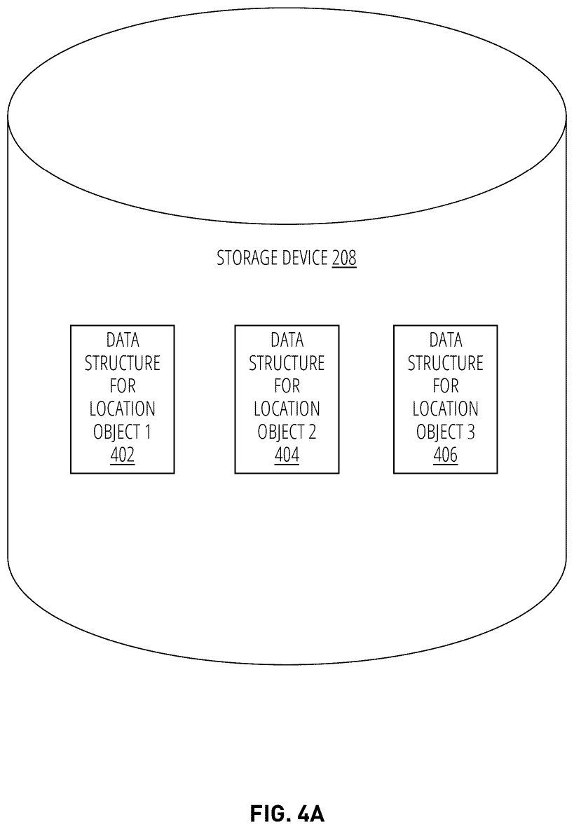

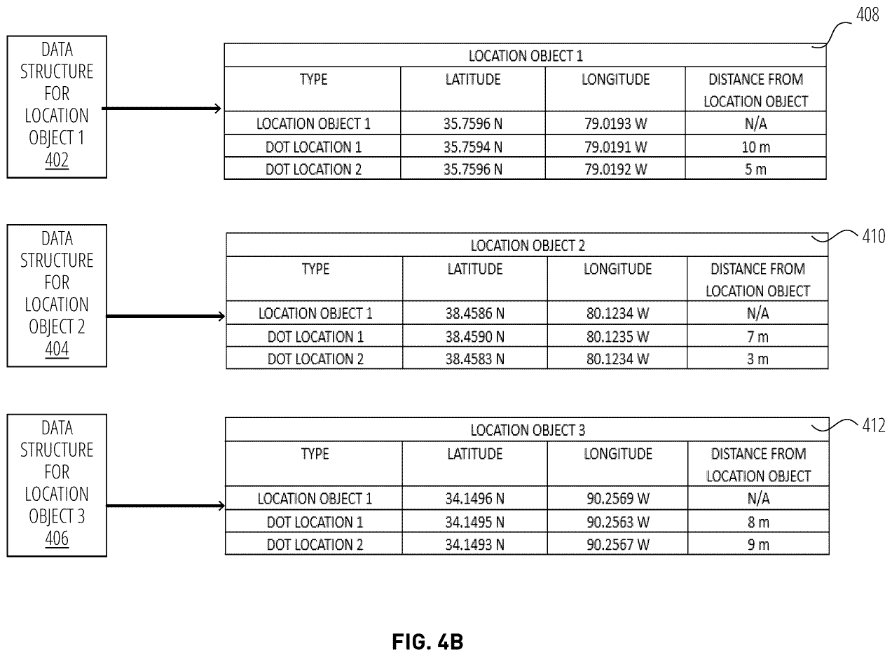

FIG. 4A is a block diagram illustrating an example storage device 208 according to some embodiments of the present disclosure. After the processing circuit 302 has performed the processing operations described above on, for example, three location objects, three data structures are generated. Namely, data structure for location object 1 402, data structure for location object 2 404, and data structure for location object 3 406 are generated as a result of the operations performed above.

In some embodiments, these data structures can be stored in memory on the storage device 208. For example, the data can be stored in a database maintained by the storage device 208.

FIG. 4B illustrates a series of tables that help visualize some example data that can be stored in the data structure for each location object. For example, Table 1 408 corresponds to the data representing the data structure for location object 1 402, Table 2 410 corresponds to the data representing the data structure for location object 2 404, and Table 3 412 corresponds to the data representing the data structure for location object 3 406.

As shown in Table 1 408, the data structure for location object 1 402 can include the coordinates (e.g., latitude and longitude) of the location object 1, as well as the dot locations associated therewith. Although only two dot locations are depicted in Table 1 408, those having ordinary skill in the art will appreciate that any number of dot locations can be included, making the Table 1 408 longer. The distance from the location object can also be depicted in Table 1 408. Similar data can be shown in Table 2 410 for data structure for location object 2 404 and in Table 3 412 for data structure for location object 3 406.

Additionally, each data structure or table can include a different number of dot locations based on a size of the location object, type of location object, or a parameter given for corresponding location objects. For example, smaller location objects (e.g., a small office) may have fewer dot locations generated, than a larger location object (e.g., farm, field, etc.). Additionally, there may be a different number of dot locations generated based on a location of the location object. For example, it may be desired to have a larger number of dot locations in a city versus a rural area, or vice versa.

The number of dot locations can be determined for a range of location objects or per location object. That is, a parameter can be selected for a plurality of location objects (e.g., a category of location objects) or the parameter can be selected per location object to determine the number and/or density of dot locations generated. The parameters can be selected by a user of the apparatus 202 via the user interface 306.

FIG. 5 depicts an example spread pattern 500 of dot locations 506 as described above. A geographic area 502 is presented with the location object 504 at the center. The dot locations 506 depicted in FIG. 5 are generated by the processing circuit 302 before the data structures for each location object 504 is generated. The spread pattern 500 also includes an example logical zone 508 drawn.

As discussed above, the logical zone 508 can be used to constrain the generation of the dot locations 506. In some embodiments, the dot locations 506 can also be drawn outside the logical zone 508. As discussed above, in FIG. 5, each of the dot locations 506 are randomly generated using the random number generator 310 from FIG. 3.

In some embodiments, the shape of the logical zone 508 or the shape of the dispersal pattern of the dot locations 506 can be round, square, rectangular, clipped by a containing geographic object, or clipped by a containing grid (e.g., geohash, S3, or Hex).

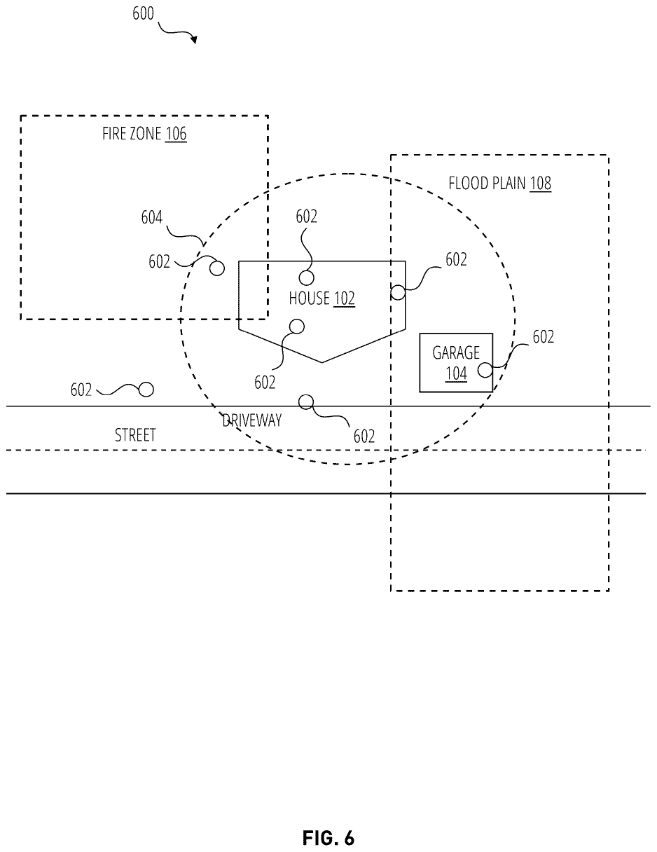

FIG. 6 illustrates an example geographic area 600 similar to FIG. 1. However, in this illustration, the house 102, which is representative of a location object from FIG. 5, is represented, not by a single dot or polygon, but by a plurality of dot locations 602. FIG. 6 depicts what could be displayed on a map interface using the data stored in the storage device 208. Namely, using the corresponding data structure stored in the storage device 208 for the house 102, the dot locations 602 can be displayed to represent the house 102, and confined within the logical zone 604 or generated outside the logical zone 604 as shown in FIG. 6.

It should be noted that the location object is not just the house, but instead the street address that represents the house 102, garage 104, or other structures on real property associated with the street address. That is, it is not just helpful to determine whether the house 102 structure is within the fire zone 106 or flood plain 108, but whether any of the real property (e.g., including the house 102, garage 104, driveway, or any land associated with the street address or location object associated with the house 102) associated with the location object is within the fire zone 106 or flood plain 108, or any other hazard.

In this way, it can be seen that the house is in both the fire zone 106 and the flood plain 108. This can be determined by comparing each of the dot locations 602 to the polygons that define the fire zone 106 and the flood plain 108. As shown in FIG. 6, there are at least two dot locations 602 that are collocated with the flood plain 108 and at least one of the dot locations 602 that is collocated with the fire zone 106. Because it is more computationally efficient to compare the dot locations 602 to the geographic coordinates embodied by the polygons of the fire zone 106 and the flood plain 108, determining that the house 102 is located within or adjacent to the fire and flood hazards, the apparatus 202 can quickly determine this fact and alert the user.

In some embodiments, instead of alerting the user that the location object embodied by the house 102 is within the fire zone 106 and the flood plain 108, the corresponding data structure for the location object can be flagged or included with an indicator indicating the hazard. In some embodiments, the specific dot location(s) in the data structure that were found to be within the hazard can also or alternatively be flagged.

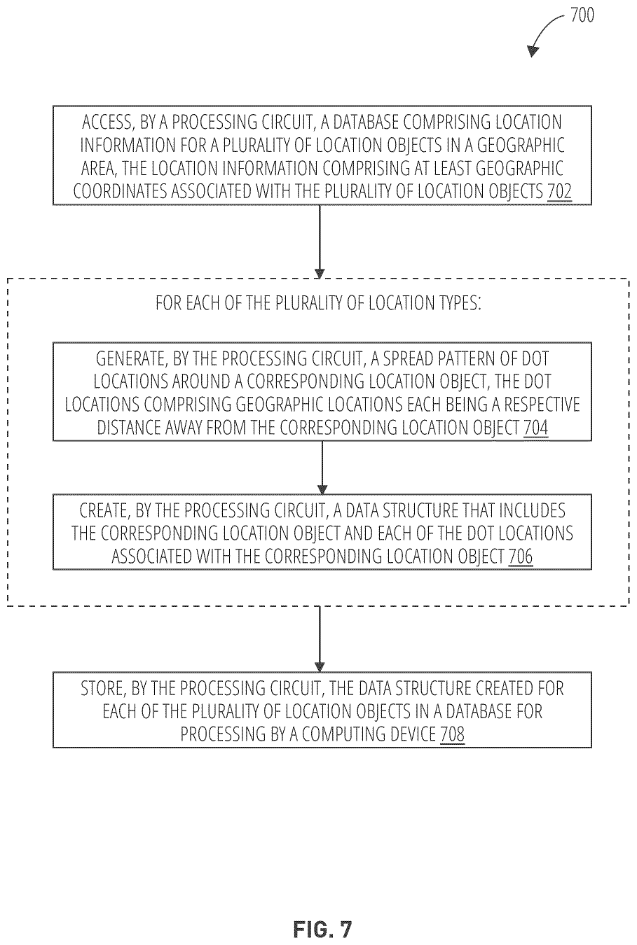

FIG. 7 is a flow chart that illustrates operations in an example method 700 according to some embodiments of the present disclosure. As shown at block 702, in some embodiments, the method 700 includes accessing, by a processing circuit, a database comprising location information for a plurality of location objects in a geographic area, the location information comprising at least geographic coordinates associated with the plurality of location objects. For each of the plurality of location objects, the method further includes various operations. For example, as shown at block 704, the method 700 includes generating, by the processing circuit, a spread pattern of dot locations around a corresponding location object, the dot locations comprising geographic locations each being a respective distance away from the corresponding location object. Additionally, as shown at block 706, the method 700 includes creating, by the processing circuit, a data structure that includes the corresponding location object and each of the dot locations associated with the corresponding location object. As shown at block 708, the method 700 further includes storing, by the processing circuit, the data structure created for each of the plurality of location objects in a storage device for processing by a computing device.

In some embodiments, the method 700 further includes generating, by the processing circuit, a logical zone of the geographic area having the corresponding location as a center point thereof and the logical zone having a radius according to a parameter. In some embodiments, generating the spread pattern of dot locations includes generating the spread pattern of dot locations within the logical zone.

In some embodiments, the method 700 further includes receiving, by the processing circuit, an input including the parameter setting the radius of the logical zone to be generated. In some other embodiments, the method 700 further includes setting the parameter to be a predefined radius based on whether the corresponding location object is located in a rural or urban area, wherein the radius is larger when the corresponding location object is located in the rural area than in the urban area. In some embodiments, generating the spread pattern of dot locations includes generating, by the processing circuit, random coordinates around the corresponding location object.

In some embodiments, the method 700 further includes receiving, by the processing circuit, input parameters including a number of dot locations to generate, a density of the dot locations, and a maximum distance from the corresponding location object that the dot locations can be generated. In some embodiments, generating the spread pattern of dot locations includes generating the dot locations according to the input parameters.

In some embodiments, the method 700 further includes receiving, by the computing device, a request to display a representation of an input location object. In such embodiments, the method 700 further includes accessing, by the computing device, the storage device and locating the data structure for the location object that corresponds to the input location object. Further, in such embodiments, the method 700 further includes displaying, by the computing device, on a map interface, the representation including the location object that corresponds to the input location object and the spread pattern of dot locations associated with the location object.

In some embodiments of the method 700, creating the data structure further includes determining, by the processing circuit, attributes for each of the dot locations associated with the corresponding location object. Creating the data structure further includes associating, by the processing circuit, the attributes with corresponding ones of the dot locations and inserting the attributes into the data structure. In some embodiments, the attributes include at least a distance from the corresponding dot location to the corresponding location object and geographic coordinates for the corresponding dot location.

In some embodiments of the method 700, generating the spread pattern of dot locations includes adjusting individual dot locations to not be collocated with known exclusion zones. In some embodiments of the method 700, the known exclusion zones include one or more of the following: hills, mountains, man-made features, dams, national parks, large vacant land, and bodies of water.

Some embodiments of the disclosed system may be implemented, for example, using a storage medium, a computer-readable medium or an article of manufacture which may store an instruction or a set of instructions that, when executed by a machine (e.g., processor, processing circuit, or microcontroller), may cause the machine to perform a method and/or operations in accordance with embodiments of the disclosure. In addition, a server or database server may include machine readable media configured to store machine executable program instructions. Such a machine may include, for example, any suitable processing platform, computing platform, computing device, processing device, computing system, processing system, computer, processor, or the like, and may be implemented using any suitable combination of hardware, software, firmware, or a combination thereof and utilized in systems, subsystems, components, or sub-components thereof.

The various elements of the devices as previously described with reference to the figures above may include various hardware elements, software elements, or a combination of both. Examples of hardware elements may include devices, logic devices, components, processors, microprocessors, circuits, processors, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements may include software components, programs, applications, computer programs, application programs, system programs, software development programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. However, determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

One or more aspects of at least one embodiment may be implemented by representative instructions stored on a non-transitory machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that make the logic or processor. Some embodiments may be implemented, for example, using a machine-readable medium or article which may store an instruction or a set of instructions that, if executed by a machine, may cause the machine to perform a method and/or operations in accordance with the embodiments. Such a machine may include, for example, any suitable processing platform, computing platform, computing device, processing device, computing system, processing system, computer, processor, or the like, and may be implemented using any suitable combination of hardware and/or software. The machine-readable medium or article may include, for example, any suitable type of memory unit, memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), a tape, a cassette, or the like. The instructions may include any suitable type of code, such as source code, compiled code, interpreted code, executable code, static code, dynamic code, encrypted code, and the like, implemented using any suitable high-level, low-level, object-oriented, visual, compiled and/or interpreted programming language.

As used herein, an element or operation recited in the singular and proceeded with the word “a” or “an” should be understood as not excluding plural elements or operations, unless such exclusion is explicitly recited. Furthermore, references to “one embodiment” of the present disclosure are not intended to be interpreted as excluding the existence of additional embodiments that also incorporate the recited features.

The present disclosure is not to be limited in scope by the specific embodiments described herein. Indeed, other various embodiments of and modifications to the present disclosure, in addition to those described herein, will be apparent to those of ordinary skill in the art from the foregoing description and accompanying drawings. Thus, such other embodiments and modifications are intended to fall within the scope of the present disclosure. Furthermore, although the present disclosure has been described herein in the context of a particular implementation in a particular environment for a particular purpose, those of ordinary skill in the art will recognize that its usefulness is not limited thereto and that the present disclosure may be beneficially implemented in any number of environments for any number of purposes. Accordingly, the claims set forth below should be construed in view of the full breadth and spirit of the present disclosure as described herein.

The foregoing description of example embodiments has been presented for the purposes of illustration and description. It is not intended to be exhaustive or to limit the present disclosure to the precise forms disclosed. Many modifications and variations are possible in light of this disclosure. It is intended that the scope of the present disclosure be limited not by this detailed description, but rather by the claims appended hereto. Future filed applications claiming priority to this application may claim the disclosed subject matter in a different manner, and may generally include any set of one or more limitations as variously disclosed or otherwise demonstrated herein.

What is claimed is:

1. A method comprising:
accessing, by a processing circuit, a database comprising location information for a plurality of location objects in a geographic area, the location information comprising at least geographic coordinates associated with the plurality of location objects;
for each of the plurality of location objects:
generating, by the processing circuit, a spread pattern of dot locations around a corresponding location object, the dot locations comprising geographic locations each being a respective distance away from the corresponding location object; and
creating, by the processing circuit, a data structure that includes the corresponding location object and each of the dot locations associated with the corresponding location object; and
storing, by the processing circuit, the data structure created for each of the plurality of location objects in a storage device for processing by a computing device.

2. The method of claim 1, wherein each of the location objects represents an address used to describe a portion of real property located in the geographic area, and the geographic coordinates comprise latitude and longitude coordinates located within the portion of real property.

3. The method of claim 1, comprising:
generating, by the processing circuit, a logical zone of the geographic area having the corresponding location object as a center point thereof and the logical zone having a radius according to a parameter;
wherein generating the spread pattern of dot locations includes generating the spread pattern of dot locations within the logical zone.

4. The method of claim 3, comprising:
receiving, by the processing circuit, an input including the parameter setting the radius of the logical zone to be generated; or
setting the parameter to be a predefined radius based on whether the corresponding location object is located in a rural or urban area, wherein the radius is larger when the corresponding location object is located in the rural area than in the urban area.

5. The method of claim 1, wherein generating the spread pattern of dot locations comprises generating, by the processing circuit, random coordinates around the corresponding location object.

6. The method of claim 5, comprising:
receiving, by the processing circuit, input parameters including a number of dot locations to generate, a density of the dot locations, and a maximum distance from the corresponding location object that the dot locations can be generated; and
wherein generating the spread pattern of dot locations includes generating the dot locations according to the input parameters.

7. The method of claim 1, comprising:
receiving, by the computing device, a request to display a representation of an input location object;
accessing, by the computing device, the storage device and locating the data structure for the location object that corresponds to the input location object; and
displaying, by the computing device, on a map interface, the representation including the location object that corresponds to the input location object and the spread pattern of dot locations associated with the location object.

8. The method of claim 1, wherein creating the data structure includes:
determining, by the processing circuit, attributes for each of the dot locations associated with the corresponding location object; and
associating, by the processing circuit, the attributes with corresponding ones of the dot locations and inserting the attributes into the data structure.

9. The method of claim 8, wherein the attributes include at least a distance from the corresponding dot location to the corresponding location object and geographic coordinates for the corresponding dot location.

10. The method of claim 1, wherein generating the spread pattern of dot locations includes adjusting individual dot locations to not be collocated with known exclusion zones; and
wherein the known exclusion zones include one or more of the following: hills, mountains, man-made features, dams, national parks, large vacant land, and bodies of water.

11. A computing apparatus comprising:
a processing circuit; and
a memory storing instructions thereon, which, when executed by the processing circuit, configure the apparatus to:
access a database comprising location information for a plurality of location objects in a geographic area, the location information comprising at least geographic coordinates associated with the plurality of location objects;
for each of the plurality of location objects:
generate a spread pattern of dot locations around a corresponding location object, the dot locations comprising geographic locations each being a respective distance away from the corresponding location object; and
create a data structure that includes the corresponding location object and each of the dot locations associated with the corresponding location object; and
store the data structure created for each of the plurality of location objects in a storage device for processing by a computing device.

12. The computing apparatus of claim 11, wherein each of the location objects represents an address used to describe a portion of real property located in the geographic area, and the geographic coordinates comprise latitude and longitude coordinates located within the portion of real property.

13. The computing apparatus of claim 11, wherein the instructions configure the apparatus to:
generate a logical zone of the geographic area having the corresponding location as a center point thereof and the logical zone having a radius according to a parameter;
wherein generating the spread pattern of dot locations includes the apparatus being configured to generate the spread pattern of dot locations within the logical zone.

14. The computing apparatus of claim 13, wherein the instructions configure the apparatus to:
receive an input including the parameter setting the radius of the logical zone to be generated; or
set the parameter to be a predefined radius based on whether the corresponding location object is located in a rural or urban area, wherein the radius is larger when the corresponding location object is located in the rural area than in the urban area.

15. The computing apparatus of claim 11, wherein generating the spread pattern of dot locations includes the apparatus being configured to generate random coordinates around the corresponding location object.

16. The computing apparatus of claim 15, wherein the instructions configure the apparatus to:
receive input parameters including a number of dot locations to generate, a density of the dot locations, and a maximum distance from the corresponding location object that the dot locations can be generated; and
wherein generating the spread pattern of dot locations includes the apparatus being configured to generate the dot locations according to the input parameters.

17. The computing apparatus of claim 11, wherein the instructions configure the apparatus to:
receive a request to display a representation of an input location object;
access the storage device and locate the data structure for the location object that corresponds to the input location object; and
display on a map interface, the representation including the location object that corresponds to the input location object and the spread pattern of dot locations associated with the location object.

18. The computing apparatus of claim 11, wherein creating the data structure includes:
determine attributes for each of the dot locations associated with the corresponding location object; and
associate the attributes with corresponding ones of the dot locations and insert the attributes into the data structure,
wherein the attributes include at least a distance from the corresponding dot location to the corresponding location object and geographic coordinates for the corresponding dot location.

19. The computing apparatus of claim 11, wherein generating the spread pattern of dot locations includes the apparatus being configured to adjust individual dot locations to not be collocated with known exclusion zones; and
wherein the known exclusion zones include one or more of hills, mountains, man-made features, dams, national parks, large vacant land, and bodies of water.

20. A non-transitory computer-readable storage medium having executable instructions stored thereon, that when executed by a processing circuit, cause the processing circuit to:
access a database comprising location information for a plurality of location objects in a geographic area, the location information comprising at least geographic coordinates associated with the plurality of location objects;
for each of the plurality of location objects:
generate a spread pattern of dot locations around a corresponding location object, the dot locations comprising geographic locations each being a respective distance away from the corresponding location object; and
create a data structure that includes the corresponding location object and each of the dot locations associated with the corresponding location object; and
store the data structure created for each of the plurality of location objects in a storage device for processing by a computing device.
